(19) United States
(12) Patent Application Publication
(10) Pub. No.: US 2020/0319836 A1
(43) Pub. Date: Oct. 8, 2020

(54) Display Unit

(71) Applicant: Sony Corporation, Tokyo (JP)

(72) Inventors: Takayuki Ohe, Saitama (JP); Akira Kubo, Tokyo (JP); Yuta Mizobata, Kanagawa (JP)

(73) Assignee: Sony Corporation, Tokyo (JP)

(21) Appl. No.: 16/766,847

(22) PCT Filed: Oct. 18, 2018
(86) PCT No.: PCT/JP2018/038838

§ 371 Date: May 26, 2020

(30) Foreign Application Priority Data
Dec. 6, 2017 (JP) 2017-234627

(51) Int. Cl. G06F 3/14; G06F 3/01; G06F 3/0484; H04R 1/02

(52) U.S. Cl. CPC G06F 3/1423; G06F 3/011; H04R 2499/15; H04R 1/028; G06F 3/04845

(57) ABSTRACT

There is provided a display unit that is able to provide a viewing environment comfortable for a viewer. This display unit includes: a first display surface where a first image is to be displayed; a second display surface that makes an inclination angle with respect to the first display surface and where a second image is to be displayed; a detector that detects a relative position of a viewer who views the first image and the second image to the first display surface and the second display surface; and a controller that corrects deformation of the first image and deformation of the second image, thereby creating a single virtual screen that faces the viewer on the basis of the relative position detected by the detector.

### TECHNICAL FIELD

The present disclosure relates to a display unit.

### BACKGROUND ART

A display unit including a flexible display panel with flexibility that is foldable or windable has been proposed before (for example, see PTL 1).

### CITATION LIST

### Patent Literature

PTL 1: Japanese Unexamined Patent Application Publication No. 2014-2348

### SUMMARY OF THE INVENTION

Recent display units are obviously increased in screen size and reduced in thickness. However, considering that a size of an interior space is limited, it is expected to become difficult to allocate a wall surface or a ceiling surface large enough to install such a large-screen display unit.

Accordingly, it is desirable to provide a display unit that is able to provide a viewing environment comfortable for a viewer even in an interior space with a limited size.

A display unit according to an embodiment of the present disclosure includes: a first display surface where a first image is to be displayed; a second display surface that makes an inclination angle with respect to the first display surface and where a second image is to be displayed; a detector that detects a relative position of a viewer who views the first image and the second image to the first display surface and the second display surface; and a controller that corrects deformation of the first image and deformation of the second image, thereby creating a single virtual screen that faces the viewer on the basis of the relative position detected by the detector.

The display unit according to the embodiment of the present disclosure is able to provide a viewing environment comfortable for a viewer.

It is to be noted that effects of the present disclosure are not necessarily limited to the effects described above, and may include any of effects that are described below.

### BRIEF DESCRIPTION OF DRAWING

FIG. 1A is a schematic diagram schematically illustrating a display unit according to a first embodiment of the present disclosure and a viewing environment thereof.

FIG. 1B is another schematic diagram schematically illustrating the display unit illustrated in FIG. 1A and the viewing environment thereof.

FIG. 2 is a block diagram illustrating a schematic configuration example of the display unit illustrated in FIG. 1A.

FIG. 3A is an explanatory diagram illustrating an example of an image based on a non-image-processed image signal received by an image processor of the display unit illustrated in FIG. 2.

FIG. 3B is an explanatory diagram illustrating a situation where a viewer views an image displayed on a display section without being image-processed in the display unit illustrated in FIG. 1A.

FIG. 3C is an explanatory diagram illustrating a situation where the viewer views an image displayed on the display section after being image-processed in the display unit illustrated in FIG. 1A.

FIG. 4 is an explanatory diagram for describing a method of image-processing in the display unit illustrated in FIG. 1.

FIG. 5A is a schematic diagram schematically illustrating a display unit according to a second embodiment of the present disclosure and a viewing environment thereof.

FIG. 5B is another schematic diagram schematically illustrating the display unit illustrated in FIG. 5A and the viewing environment thereof.

FIG. 6 is an explanatory diagram illustrating a method of image-processing in the display unit illustrated in FIG. 5A.

FIG. 7 is a schematic diagram illustrating a display unit according to a third embodiment of the present disclosure and a use method thereof.

FIG. 8A is a schematic diagram illustrating one mode of a display unit according to a fourth embodiment of the present disclosure.

FIG. 8B is a schematic diagram illustrating another mode of the display unit illustrated in FIG. 8A.

FIG. 9A is a schematic diagram illustrating a use example of the display unit illustrated in FIG. 8A.

FIG. 9B is a schematic diagram illustrating another use example of the display unit illustrated in FIG. 8A.

FIG. 10 is a schematic diagram schematically illustrating a display unit as a first modification example of the display unit illustrated in FIG. 1A and a viewing environment thereof.

FIG. 11 is a schematic diagram schematically illustrating a display unit as a second modification example of the display unit illustrated in FIG. 1A and a viewing environment thereof.

### MODES FOR CARRYING OUT THE INVENTION

In the following, embodiments of the present disclosure are described in detail with reference to the drawings. It is to be noted that description is made in the following order.
1. First Embodiment

An example of a display unit that creates a single virtual screen by correcting two images displayed on two non-parallel display surfaces
2. Second Embodiment

An example of a display unit that has a curved display surface, and creates, in accordance with a position of a viewer, a virtual screen that faces the viewer
3. Third Embodiment

An example of a display unit including a flexible display that is windable and drawable and is able to cover a cable of an electronic apparatus
4. Fourth Embodiment

An example of a display unit including a drape-curtain flexible display that is changeable in state between a folded state and an unfolded state
5. Modification Examples

### 1. FIRST EMBODIMENT

### [Configuration of Display Unit 1]

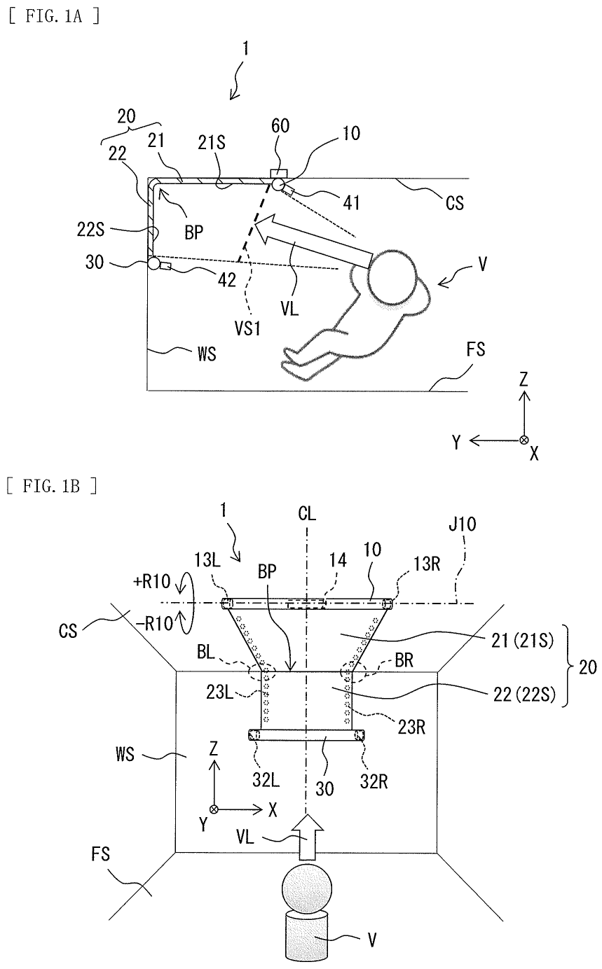

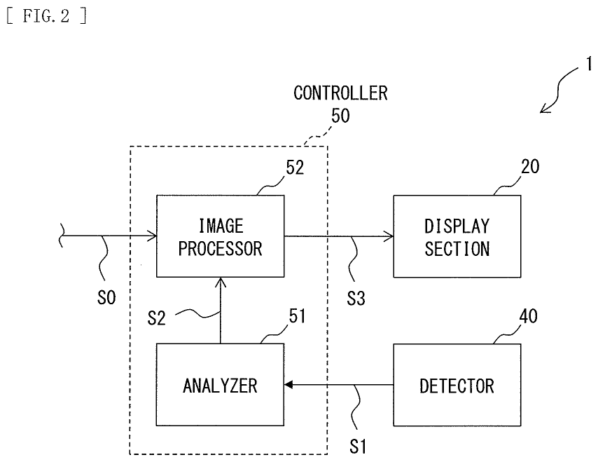

FIG. 1A is a schematic diagram illustrating a display unit 1 according to a first embodiment of the present disclosure and a viewing environment of a viewer V who views the display unit 1. FIG. 1B is another schematic diagram where the display unit 1 and the viewing environment thereof are illustrated from a direction different from that of FIG. 1A. Further, FIG. 2 is a block diagram illustrating a schematic configuration example of the display unit 1.

As illustrated in FIG. 1A and FIG. 1B, the display unit 1 is installed in an interior space having a floor surface FS, a wall surface WS erected on the floor surface FS, and a ceiling surface CS opposed to the floor surface FS in a vertical direction. More specifically, the display unit 1 is disposed continuously from the ceiling surface CS to the wall surface WS. It is to be noted that in this description, the vertical direction is referred to as a Z-axis direction, a horizontal direction that is orthogonal to the Z-axis direction and parallel with the wall surface WS is referred to as an X-axis direction, and a direction orthogonal to the wall surface WS is referred to as a Y-axis direction.

As illustrated in FIG. 1A, the display unit 1 includes a winder 10, a display section 20, an unwinder 30, and a power supply 60. As illustrated in FIG. 2, the display unit 1 further includes a detector 40 and a controller 50.

### (Winder 10)

The winder 10 is disposed on the ceiling surface CS and includes a cylindrical shaft that is rotatable bidirectionally in a +R10 direction and a −R10 direction around a rotary axis J10 as illustrated in FIG. 1B. For example, rotation of the shaft of the winder 10 around the rotary axis J10 in the −10R direction enables the display section 20, which is in a form of sheet with flexibility, to be wound. The shaft of the winder 10 is a substantially cylindrical member including a material with a rigidity higher than that of the flexible display, examples of which include a metal material such as stainless steel and a hard resin. Speakers 13L and 13R, a control board 14, etc. are disposed inside the shaft of the winder 10. Moreover, rotation of the shaft of the winder 10 around the rotary axis J10 in the +R10 direction causes sequential ejection of the display section 20. It is to be noted that the rotary axis J10 is parallel with an X-axis in the present embodiment.

The speakers 13L and 13R are each an actuator that reproduces sound information. The speaker 13L is disposed in the winder 10 near a left end portion as seen from the viewer and the speaker 13R is disposed in the winder 10 near a right end portion as seen from the viewer.

The control board 14 includes, for example, an operation receiver that receives an operation from the viewer, a power receiver that receives power supplied from the power supply 60 disposed on, for example, the ceiling surface CS in a contactless manner, an NFC communicator that performs external data communication, etc. The control board 14 preferably further includes a RAM (Random Access Memory), a ROM (Read Only Memory), a CPU (Central Processing Unit), etc., for example. The ROM is a rewritable non-volatile memory that stores a variety of information to be used by the display unit 1. The ROM stores a program to be executed by the display unit 1 and a variety of setting information based on various information detected by the detector 40. The CPU controls an operation of the display unit 1 by executing various programs stored in the ROM. The RAM functions as a temporal storage region in a case where this CPU execute a program.

The winder 10 is further provided with an imaging unit 41 that acquires an image of the viewer V seen from the winder 10 and information regarding a distance between the winder 10 and the viewer V. It is to be noted that the imaging unit 41 is a component of the detector 40 (FIG. 2).

### (Display Section 20)

The display section 20 is a so-called flexible display, and a single sheet-shaped display device with flexibility. The display section 20 is able to be wound and stowed in the winder 10 with the rotation of the shaft of the winder 10. The display section 20 includes a first display portion 21 having a first display surface 21S and a second display portion 22 having a second display surface 22S. A first image and a second image are displayed respectively on the first display surface 21S and the second display surface 22S on the basis of an image signal supplied from a later-described image processor 52. The first display surface 21S and the second display surface 22S make an inclination angle with respect to each other. In the example of FIG. 1A and FIG. 1B, the first display portion 21 having the first display surface 21S is disposed on the ceiling surface CS and the second display portion 22 having the second display surface 22S is disposed on the wall surface WS. The display section 20 includes two flexible films with a plurality of pixels using a self-emitting device such as an organic EL (Electro Luminescence) device or a display device such as a liquid crystal device therebetween, for example.

One end of the display section 20 is coupled to the winder 10 and another end of the display section 20 is coupled to the unwinder 30. The rotation of the winder 10 around the rotary axis J10 in the −R10 direction causes the display section 20 to be wound in the winder 10. Further, the rotation of the winder 10 around the rotary axis J10 in the +R10 direction causes the display section 20 to be ejected from the winder 10 in a +Y direction along the ceiling surface CS and then unwound in a −Z direction, or downward, along the wall surface WS.

A plurality of piezoelectric sensors 23 arranged along, for example, both X-axial edges is disposed behind the first display surface 21S and the second display surface 22S of the display section 20. Each of the plurality of piezoelectric sensors 23 is a passive device including a piezoelectric body that converts applied force to voltage. Thus, in response to application of an external force, such as bending or twisting, to the first display surface 21S and the second display surface 22S of the display section 20, stress is applied to the plurality of piezoelectric sensors 23. The stress corresponds to a position of each of the piezoelectric sensors 23. For this reason, the plurality of piezoelectric sensors 23 individually functions as bend detection sensors that detect curvatures of the first display surface 21S and the second display surface 22S. This plurality of piezoelectric sensors 23 detects inflection points BL and BR of the display section 20. It is to be noted that each of the plurality of piezoelectric sensors 23 is also a component of the detector 40 (FIG. 2).

### (Unwinder 30)

The unwinder 30 is coupled to a distal end of the display section 20. Similarly to, for example, the winder 10, the unwinder 30 is a substantially cylindrical member including a material with a rigidity higher than that of the display section 20, examples of which include a metal material such as stainless steel and a hard resin. However, the unwinder 30 includes no shaft that is rotatable itself unlike the winder 10, though being movable away from the winder 10 or toward the winder 10. Speakers 32L and 32R, etc. are disposed inside the unwinder 30. The unwinder 30 is further provided with an imaging unit 42 that acquires an image of the viewer V seen from the unwinder 30 and information regarding a distance between the unwinder 30 and the viewer V. It is to be noted that the imaging unit 42 is also a component of the detector 40 (FIG. 2).

### (Detector 40)

The detector 40 includes the imaging unit 41 disposed at the winder 10, the plurality of piezoelectric sensors 23 disposed at the display section 20, and the imaging unit 42 disposed at the unwinder 30 as described above. The detector 40 functions to acquire a variety of information regarding the display unit 1 with the above variety of sensors and send the variety of information as a detection signal Si to an analyzer 51 (described later) of the controller 50 as illustrated in FIG. 2, for example. The variety of information includes: the image of the viewer V and information regarding a distance from the imaging unit 41 to the viewer V acquired by the imaging unit 41; and the image of the viewer V and information regarding a distance from the imaging unit 42 to the viewer V detected by the imaging unit 42, for example. Further, the variety of information also includes information regarding positions of the inflection points BL and BR of the display section 20 detected by the plurality of piezoelectric sensors 23.

### (Controller 50)

The controller 50 includes the analyzer 51 and the image processor 52 as, for example, functions of the CPU provided on the control board 14 as illustrated in FIG. 2.

The analyzer 51 analyzes the variety of information sent from the detector 40 and estimates, as a result of the analysis, a state of the display unit 1, examples of which include states of the first display surface 21S and the second display surface 22S. Specifically, the analyzer 51 analyzes changes in respective voltages detected by the plurality of piezoelectric sensors 23, thereby making it possible to estimate which portion of the display surface of the display section 20 has bend or deformation and an amount of the bend or deformation. That is, a position of a folding line BP corresponding to a boundary position between the first display portion 21 and the second display portion 22 is estimated. The folding line BP refers to a line that connects the inflection point BL and the inflection point BR. Further, the analyzer 51 collectively analyzes: the image of the viewer V and the distance information from the imaging unit 41 to the viewer V detected by the imaging unit 41; and the image of the viewer V and the distance information from the imaging unit 42 to the viewer V detected by the imaging unit 42, thereby making it possible to estimate a relative position of the viewer V to the first display surface 21S and the second display surface 22S. That is, it is possible to estimate a position of a face of the viewer V or a position of both eyes of the viewer V relative to the first display surface 21S and the second display surface 22S. Further, the analyzer 51 is also able to obtain an inclination of a line that connects both eyes of the viewer V relative to the horizontal direction, that is, an inclination of the face of the viewer V in a right-left direction by analyzing the images of the viewer V detected by the imaging units 41 and 42. Further, the analyzer 51 is also able to determine whether the viewer V is asleep or awake by analyzing the images of the viewer V detected by the imaging units 41 and 42.

The analyzer 51 sends the result of the analysis as an analysis signal S2 to the image processor 52. The image processor 52 creates a less deformed virtual screen VS1 that faces the viewer V on the basis of the result of the analysis by the analyzer 51. That is, the image processor 52 creates the virtual screen VS1 on the basis of the folding line BP of the display section 20 detected by the plurality of piezoelectric sensors 23 and the relative position of the viewer V to the first display surface 21S and the second display surface 22S detected by the imaging units 41 and 42. The virtual screen VS1 is created on a line of vision VL of the viewer V. Moreover, the image processor 52 may incline the virtual screen VS1 on the basis of the inclination of the face of the viewer V in the right-left direction relative to the horizontal direction. In this case, the image processor 52 performs image processing, that is, corrects a deformation of the first image on the first display surface 21S based on an externally inputted image signal S0 and a deformation of the second image displayed on the second display surface 22S based on the image signal S0. The image processor 52 sends an image-processed image signal S3 to the display section 20 (FIG. 2).

### (Power Supply 60)

The power supply 60 is a contactless power supply member that is disposed near the winder 10 and supplies power to the display section 20. It is to be noted that the power supply 60 does not have to be a contactless power supply member but may be a contact power supply member. However, a contactless power supply member is preferable in terms of an improvement in design flexibility.

### [Operation of Display Unit 1]

### (A. Basic Operation)

First, description will be made on a basic operation of the display unit 1. This display unit 1 is in a stored state when turned off. That is, the display section 20 is stored in the winder 10, and the winder 10 and the unwinder 30 are closest to each other. When the display unit 1 is turned on by operating a remote controller or the like by the viewer V or the like, the display unit 1 shifts from the stored state to an unwound state illustrated in FIG. 1A and FIG. 1B. The display unit 1 may be turned on by voice instructions or by externally inputting the image signal S0 to the image processor 52. Moreover, this display unit 1 may cause the detector 40 to acquire the images of the viewer V, the information regarding the distance between each of the imaging units 41 and 42 and the viewer V, or the information regarding the positions of the inflection points BL and BR of the display section 20 at all times in accordance with, for example, instructions of the controller 50. This variety of acquired information is stored in the ROM or the like of the control board 14.

In this display unit 1, as illustrated in FIG. 2, the image processor 52 performs the image processing on the externally inputted image signal SO and the image signal S3 generated by the image processor 52 is inputted to the display section 20. The image processing includes switching control of a display mode of an image performed on the basis of the analysis signal S2 from the analyzer 51. The analyzer 51 performs the analysis on the basis of the variety of information contained in the detection signal 51 from the detector 40. An image is displayed on the display section 20 in a display mode based on the image signal S3 from the image processor 52.

### (B. Detailed Operation)

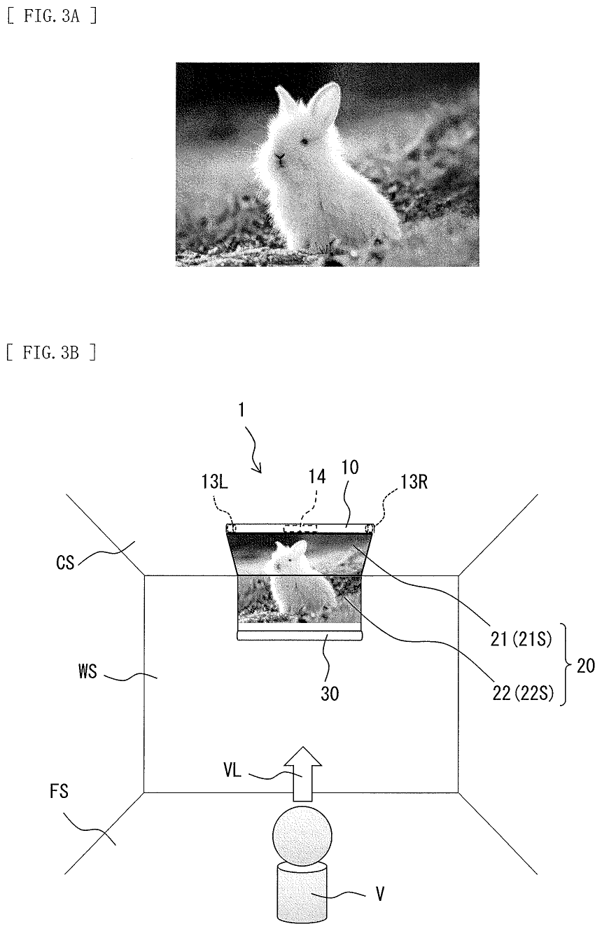

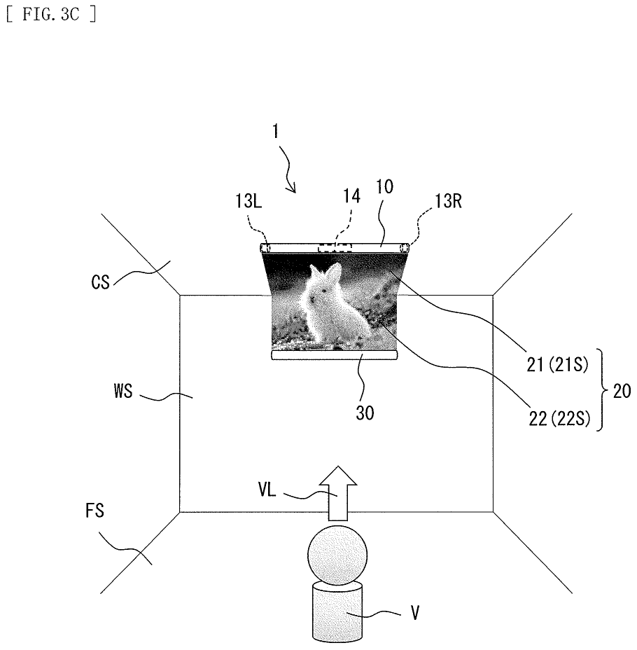

Next, referring to FIG. 3A to FIG. 3C and FIG. 4, description will be made on a detailed operation of the display unit 1.

FIG. 3A illustrates an example of an image, which is viewed from the front, based on the non-image-processed image signal S0 received by the image processor 52 of the display unit 1. FIG. 3B illustrates a situation where the image illustrated in FIG. 3A is displayed on the display section 20 of the display unit 1 without being image-processed in the image processor 52 and the viewer V views the image. In this case, as illustrated in FIG. 3B, roughly an upper half of the image is displayed on the first display surface 21S of the first display portion 21 and roughly a lower half of the image is displayed on the second display surface 22S of the second display portion 22. However, the viewer V looks up at the display section 20 from below to view the image; therefore, both the image on the first display surface 21S and the image on the second display surface 22S look deformed to the viewer V. In particular, the first display surface 21S and the second display surface 22S are non-parallel with each other in an example in the present embodiment. For this reason, a deformation manner of the image on the first display surface 21S is different from a deformation manner of the image on the second display surface 22S. For example, the image on the first display surface 21S is more considerably squashed in an up-down direction than the image on the second display surface 22S. This makes it difficult for the viewer V to recognize the image on the first display surface 21S and the image on the second display surface 22S as a single continuous image.

Accordingly, in the display unit 1 according to the present embodiment, the analyzer 51 analyzes the detection signal 51 and the image processor 52 performs appropriate image processing on the basis of the analysis signal S2 from the analyzer 51, thereby creating the virtual screen VS1 with less deformation. That is, the first display surface 21S and the second display surface 22S are accurately cut out on the basis of the information regarding the positions of the inflection points BL and BR of the display section 20 and respective images that are supposed to be displayed thereon are appropriately corrected. For example, the image to be displayed on the first display surface 21S located on the ceiling surface CS will look deformed in an inverted trapezoid with an upper base that is longer than a lower base unless being image-processed. Accordingly, the image to be displayed on the first display surface 21S is preferably subjected to linear interpolation to make an enlargement ratio of a vicinity of the upper base higher than an enlargement ratio of a vicinity of the lower base. Meanwhile, the image to be displayed on the second display surface 22S located above and in front of the viewer V will look deformed in a trapezoid with an upper base that is shorter than a lower base unless being image-processed. Accordingly, the image to be displayed on the second display surface 22S is preferably subjected to linear interpolation to make an enlargement ratio of a vicinity of the upper base lower than an enlargement ratio of a vicinity of the lower base. The controller 50 sends the image signal S3 having been subjected to such image processing to the display section 20 from the image processor 52 and causes the image-processed images to be displayed on the respective first display surface 21S and the second display surface 22S. As a result, as illustrated in FIG. 3C, the less deformed image is displayed on the display section 20 at a facing position relative to the viewer V on an extension of the line of vision VL. It is to be noted that FIG. 3C illustrates a situation where the image illustrated in FIG. 3A is displayed on the display section 20 of the display unit 1 after being image-processed in the image processor 52 and the viewer V views the image.

FIG. 4 is a schematic diagram for describing a magnification ratio for performing the above linear interpolation. As illustrated in FIG. 4, a distance from a viewing position of the viewer V, which is, for example, the position of both eyes, to an upper end position of the first display portion 21 is denoted by LU. Moreover, a distance from the viewing position of the viewer V to a lower end position of the first display portion 21, i.e., the folding line BP, is denoted by LM. Further, a distance from the viewing position of the viewer V to a lower end position of the second display portion 22 is denoted by LL. Here, it is assumed that an upper end position of the virtual screen VS1 is aligned with the upper end position of the first display portion 21. In this case, to create the virtual screen VS1, the image-processed image to be displayed on an upper end of the first display portion 21 is one time as large as a non-image-processed image. Meanwhile, an image-processed image to be displayed on a lower end of the first display portion 21 is (LM/LU) times as large as a non-image-processed image. Further, an image-processed image between the upper end of the first display portion 21 and the lower end of the first display portion 21 is subjected to linear interpolation at a magnification ratio in a range from one time to (LM/LU) times of a non-image-processed image. Likewise, an image-processed image to be displayed on an upper end of the second display portion 22 is (LM/LU) times as large as a non-image-processed image. Meanwhile, an image-processed image to be displayed on a lower end of the second display portion 22 is (LL/LU) times as large as a non-image-processed image. Further, an image-processed image between the upper end of the second display portion 22 and the lower end of the second display portion 22 is subjected to linear interpolation at a magnification ratio in a range from (LM/LU) times to (LL/LU) times of a non-image-processed image. It is to be noted that a portion of the image-processed image that protrudes out of both of the first display surface 21S and the second display surface 22S is cut off. Alternatively, instead of being cut off, the entire image may be displayed on the display section 20 by being size-reduced at a magnification ratio according to an amount of protrusion. However, in the case of size-reducing the entire image, a black display portion is sometimes generated in at least one of an upper portion, a lower portion, a left portion, or a right portion of the display section 20.

### [Workings and Effects of Display Unit 1]

As described above, the display unit 1 creates the single virtual screen VS1 that faces the viewer V on the basis of the relative position of the viewer V to the first display surface 21S and the second display surface 22S detected by the detector 40. Therefore, the display unit 1 creates the virtual screen VS1 easy for the viewer V to see in accordance with an attitude of the viewer V, thus providing a comfortable viewing environment for the viewer V.

In addition, the display section 20 having the first display surface 21S and the second display surface 22S is in the form of a flexible display; therefore, the display unit 1 is favorable in terms of reduction in thickness and weight and has improved flexibility in installation location. The display section 20, which is able to be stored in the winder 10, is unlikely to bring an oppressive feeling to a person in the room when the display section 20 is not viewed.

In addition, the display section 20 includes the piezoelectric sensors 23 as the bend detection sensors; therefore, the display unit 1 is able to detect the boundary position between the first display surface 21S and the second display surface 22S, that is, the inflection points BL and BR. For this reason, the deformation of the first image and the deformation of the second image are appropriately corrected irrespective of changes in the positions of the inflection points BL and BR by a change in the installation position of the display unit 1. As a result, a comfortable viewing environment for the viewer is provided. Further, the controller 50 preferably creates the virtual screen VS1 on the basis of a curvature of the display section 20 detected by the piezoelectric sensors 23. This is because it is possible to correct the deformation with higher accuracy, providing a more comfortable viewing environment for the viewer.

### 2. SECOND EMBODIMENT

### [Configuration of Display Unit 2]

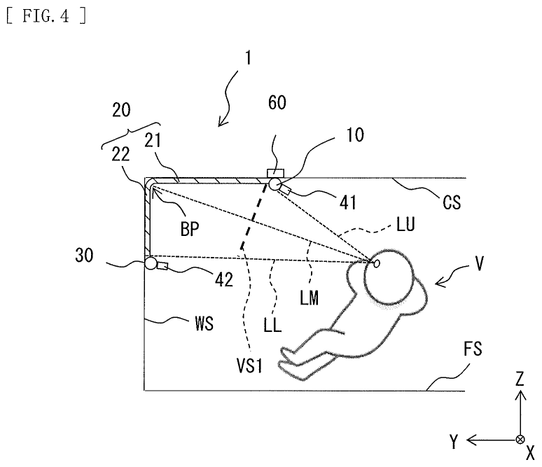

FIG. 5A is a schematic diagram illustrating a display unit 2 as a second embodiment of the present disclosure and a viewer V who views the display unit 2, which are observed from right above. FIG. 5B is a schematic diagram illustrating the display unit 2 and the viewer V who views the display unit 2, which are observed obliquely from above.

As illustrated in FIG. 5A and FIG. 5B, the display unit 2 includes a substantially cylindrical display section 24, an axial direction of which is the vertical direction. The display section 24 has a display surface 24S in an outer circumferential surface thereof and is provided with a slit 24K that extends in the vertical direction at a portion of the display section 24 along a circumferential direction (a direction of an arrow Y24). The display section 24 is also a sheet-shaped display device with flexibility similarly to the display section 20. An increase and a reduction in a width of the slit 24K in the circumferential direction of the display section 24 thus cause an increase and a reduction in an inner diameter 24D thereof. In addition, the plurality of piezoelectric sensors 23 is disposed behind the display surface 24S of the display section 24 along the circumferential direction. This plurality of piezoelectric sensors 23 detects and estimates a change in a curvature of the display surface 24S with a change in the inner diameter 24D. Further, a plurality of imaging units 43 is disposed near an upper end 24U of the display section 24 along the circumferential direction of the display section 24.

The display unit 2 includes the detector 40 and the controller 50 similarly to the display unit 1 (FIG. 2). However, the detector 40 of the display unit 2 includes the plurality of piezoelectric sensors 23 and the plurality of imaging units 43.

In the display unit 2, images of the viewer V and distance information detected by the imaging units 43 and a variety of information such as changes in respective voltages detected by the plurality of piezoelectric sensors 23 are sent as the detection signal S1 to the analyzer 51 of the controller 50. It is to be noted that this display unit 2 may cause the detector 40 to acquire the images of the viewer V, the information regarding the distance between each of the imaging units 43 and the viewer V, or the information regarding the changes in the voltages detected by the plurality of piezoelectric sensors 23 at all times in accordance with, for example, instructions of the controller 50. This variety of acquired information is stored in the ROM or the like of the control board 14. The analyzer 51 calculates the position and inclination of the face and the position of both eyes of the viewer V, etc. on the basis of the detection signal S1, and calculates a curvature of a portion of the display surface 24S that faces the viewer V, and sends them as the analysis signal S2 to the image processor 52. The image processor 52 creates a flat virtual screen VS2 that faces the viewer V on the basis of the analysis signal S2. The flat virtual screen VS2 that faces the viewer V is orthogonal to image light L directed to the viewer V.

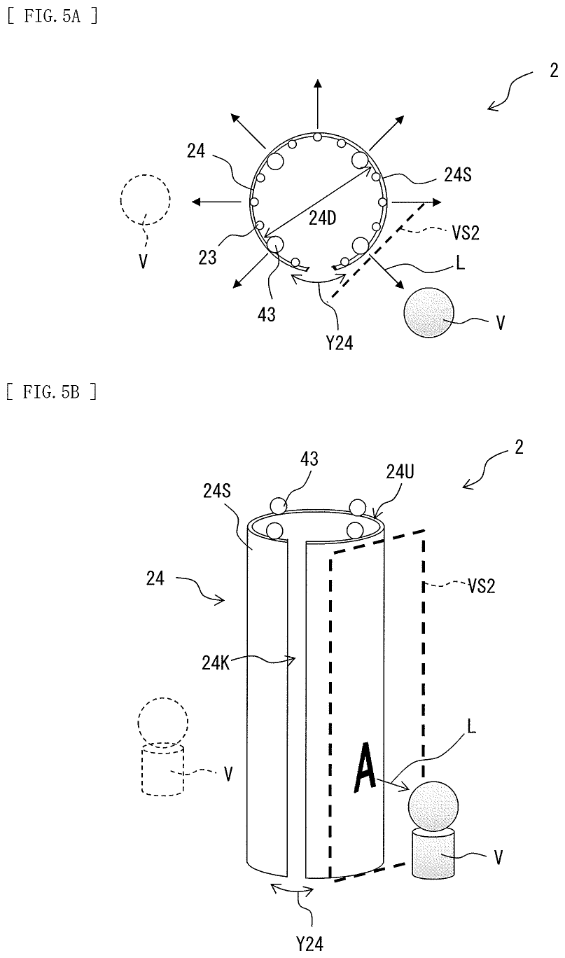

FIG. 6 is a schematic diagram for describing non-linear interpolation for creating the above-described virtual screen VS2. As illustrated in FIG. 6, a minimum distance from the viewing position of the viewer V, which is, for example, the position of both eyes, to the display surface 24S is denoted by LM. Further, a distance from the viewing position of the viewer V to a position of a right limit visible to the viewer V is denoted by LR and a distance from the viewing position of the viewer V to a position of a left limit visible to the viewer V is denoted by LL. Here, it is assumed that a position of a middle of the virtual screen VS2 in the right-left direction is set at a position of the display surface 24S spaced from the viewing position of the viewer V by a distance LR, that is, a middle position in the right-left direction (i.e., the direction of the arrows Y24) in the display surface 24S visible to the viewer V. In this case, to create the virtual screen VS2, an image-processed image to be displayed at the position of the right limit visible to the viewer V is (LR/LM) times as large as a non-image-processed image. Likewise, an image-processed image to be displayed at the position of the left limit visible to the viewer V is (LL/LM) times as large as a non-image-processed image. Further, an image-processed image between the position of the right limit visible to the viewer V and the middle position is subjected to non-linear interpolation in accordance with the curvature at a magnification ratio in a range from one time to (LR/LM) times of a non-image-processed image. Likewise, an image-processed image between the position of the left limit visible to the viewer V and the middle position is subjected to non-linear interpolation in accordance with the curvature at a magnification ratio in a range from one time to (LL/LM) times of a non-image-processed image.

### [Workings and Effects of Display Unit 2]

As described above, the display unit 2 creates the virtual screen VS2 that faces the viewer V in accordance with the position of the viewer V on the basis of the relative position of the viewer V and the curvature of the display surface 24S detected by the detector 40. This makes it possible to correct the deformation with higher accuracy irrespective of movement of the viewer V, providing a more comfortable viewing environment for the viewer. For example, the viewer V views an image of a stereoscopic object while moving along the circumferential direction of the display surface 24S, which makes it possible for the viewer V to virtually experience a realistic sensation, feeling as if the stereoscopic object were actually placed there.

### 3. THIRD EMBODIMENT

### [Configuration of Display Unit 3]

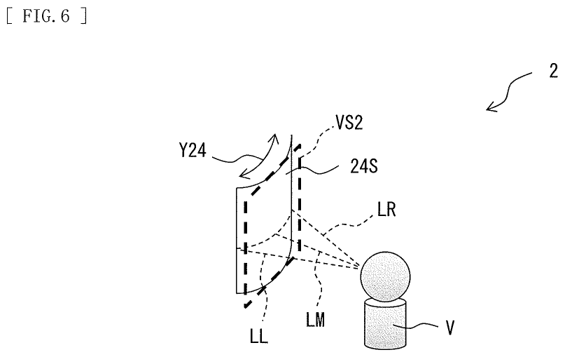

FIG. 7 is a schematic diagram illustrating a display unit 3 according to a third embodiment of the present disclosure and a use method of the display unit 3. This display unit 3 is installed on a wall surface along with an electronic apparatus including an electronic apparatus body 100 and a cable 101 taken from the electronic apparatus body 100. The display unit 3 includes the winder 10 and the display section 20 similarly to the display unit 1 according to the above-described first embodiment. The winder 10, which has the rotary axis J10, is disposed behind the electronic apparatus body 100, that is, between the electronic apparatus body 100 and the wall surface. The display section 20, which is a so-called flexible display, is windable with rotation of the rotary axis J10 and drawable downward, i.e., in a −Z direction, from the winder 10. It is to be noted that the display section 20 is located in front of the cable 101 with respect to the viewer when drawn from the winder 10.

### [Workings and Effects of Display Unit 3]

In this display unit 3, the display section 20 is able to be wound and stowed inside the winder 10 with rotation of the rotary axis J10 in the −R10 direction, for example. For this reason, in a case where a distal end 20T of the display section 20 is at, for example, a position P1 to be located behind at least the electronic apparatus body 100, the display section 20 of the display unit 3 itself is not visible to the viewer. From this state, for example, the display section 20 is drawn from the winder 10 until the distal end 20T of the display section 20 reaches a position P3 via a position P2 from the position P1, thereby making it possible to hide the cable 101 behind the display section 20. At that time, it is possible to provide a comfortable interior environment for the viewer by displaying an image of a pattern similar to that of the surrounding wall surface or an image with high affinity with the surrounding wall surface on the display section 20. In a case where the electronic apparatus body 100 includes a display unit, an image associated with an image displayed on the electronic apparatus body 100 may be displayed on the display section 20.

As described above, in the display unit 3 according to the present embodiment, it is possible to display, on the display section 20, an image that matches a surrounding environment while covering the cable 101 with the display section 20. This provides a comfortable viewing environment for the viewer.

### 4. FOURTH EMBODIMENT

### [Configuration of Display Unit 4]

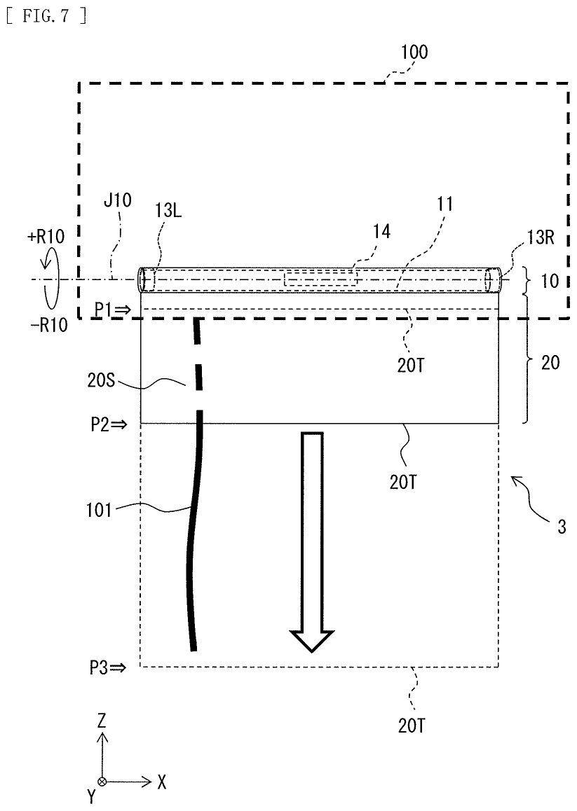

FIG. 8A and FIG. 8B are each a schematic diagram schematically illustrating an entire configuration example of a display unit 4 according to a fourth embodiment of the present disclosure. In particular, FIG. 8A illustrates one mode of a later-described folded state and FIG. 8B illustrates one mode of a later-described unfolded state. The display unit 4 includes a rail 61 extending in the horizontal direction as a first direction, and a display section 20D handing on the rail 61, for example. Power is preferably supplied to the display section 20D through the rail 61.

The display section 20D, which is in a form of a flexible display having a display surface 20DS, is provided with a plurality of pleats 20P1 and 20P2 similarly to a drape curtain. The display section 20D is thus changeable in state between a state where the display section 20D is folded along an extending direction of the rail 61 with a reduced dimension, that is, the folded state of FIG. 8A, and a state where the display section 20D spreads along the extending direction of the rail 61, that is, the unfolded state of FIG. 8B. The pleats 20P1 and 20P2 of the display section 20D refer to folds extending in the vertical direction, as a second direction, intersecting the extending direction of the rail 61. In the display section 20D, the pleats 20P1, which are peaks of mountain portions, and the pleats 20P2, which are bottoms of valley portions, are alternately arranged in the horizontal direction.

The display unit 4 includes the detector 40 and the controller 50 similarly to the display unit 1 (FIG. 2). However, the detector 40 of the display unit 4 includes a plurality of position sensors 62 arranged along the extending direction of the rail 61. The plurality of position sensors 62 includes imaging units that detect respective positions of the plurality of pleats 20P1 in the extending direction of the rail 61, for example. The display section 20D of the display unit 4 also includes the plurality of piezoelectric sensors 23 similarly to the display unit 1. The plurality of piezoelectric sensors 23 is arranged along the extending direction of the rail 61, for example. The plurality of position sensors 62 detects the respective positions of the plurality of pleats 20P1 and the plurality of piezoelectric sensors 23 detects changes in respective voltages, thereby allowing the controller 50 or the like to estimate a shape of the display surface 20DS and an amount of slack of the display surface 20DS.

### [Workings and Effects of Display Unit 4]

To display an image on the display surface 20DS of the display section 20D in the display unit 4, as illustrated in FIG. 8B, a right end of the display section 20D is manually unfolded rightward as illustrated by an arrow Y4 by a viewer him- or herself to cause the display surface 20DS to become nearly a flat surface, for example. The position sensors 62 detect that the state has changed from the folded state of FIG. 8A to the unfolded state of FIG. 8B. Here, a function member 63 that exhibits high rigidity when energized while exhibiting flexibility when not energized, such as biometal fiber, is preferably attached to the display section 20D. The function member 63 is energized to maintain flatness of the display surface 20DS in a case of displaying an image on the display surface 20DS, whereas this material is not energized to allow the display section 20D to be folded in a case of displaying no image on the display surface 20DS.

When the display unit 4 is turned on by an operation of a remote controller or the like in the unfolded state, an image based on the image signal S3 (FIG. 2) is displayed on the display surface 20DS. It is to be noted that the display unit 4 may be turned on by voice instructions or by externally inputting the image signal S0 to the image processor 52. Alternatively, the display unit 4 may be turned on in response to detection of start or completion of a change in state from the folded state to the unfolded state. Further, a turning-off operation of the display unit 4 may be performed in response to detection of start or completion of a change in state from the unfolded state to the folded state, for example.

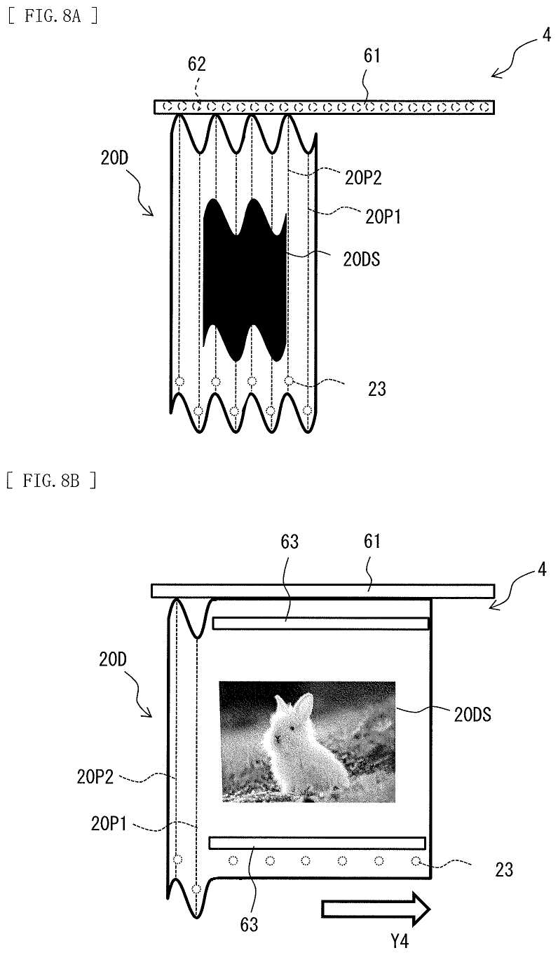

Moreover, as illustrated in FIG. 9A and FIG. 9B, it is also possible to display an image on the display surface 20DS in the folded state. FIG. 9A illustrates an example where text information is displayed along one of the pleats 20P1 of the display section 20D in the folded state. FIG. 9B illustrates an example where a flat virtual screen VS4 along, for example, the horizontal direction and the vertical direction is created. Here, the shape or the like of the display surface 20DS is estimated on the basis of the positions of the plurality of pleats 20P1 by the plurality of position sensors 62 and the changes in respective voltages by the plurality of piezoelectric sensors 23 and the image processor 52 creates the virtual screen VS4. A size of the virtual screen VS4 created in FIG. 9B changes in accordance with a horizontal dimension of the display section 20D. That is, the horizontal dimension of the display section 20D is estimated from the positions of the plurality of pleats 20P1 detected by the plurality of position sensors 62; therefore, the size of the virtual screen VS4 changes in accordance with a drawing amount of the display section 20D, i.e., an extent of the display section 20D.

As described above, the display unit 4 according to the present embodiment includes the display section 20D with flexibility, which is in the form of a drape curtain hanging on the rail 61 extending in the horizontal direction. This makes it possible to retract the display section 20D into a compact size when the display section 20B is not in use while promptly unfold the display section 20D when the display section 20D is in use. Therefore, it is possible to provide user-friendliness and comfortable interior environment to the viewer.

Moreover, the controller 50 of the display unit 4 estimates a shape of the display surface 20DS on the basis of the detection signal Si from each of the piezoelectric sensors 23 and the position sensors 62 and corrects an image on the basis of the shape to create the virtual screen VS4. This makes it possible for the viewer to view an image with less deformation even if the display section 20D is not in a fully unfolded state.

Moreover, the display unit 4 may be turned on, for example, during a change in the state of the display section 20D from the folded state toward the unfolded state or when the unfolded state is reached. In addition, the display unit 4 may be turned off during a change in the state of the display section 20D from the unfolded state toward the folded state or when the display section 20D reaches the folded state. This improves user-friendliness to the viewer.

Moreover, the display unit 4 includes the position sensors 62, allowing for changing a size of an image displayed on the display surface 20DS in accordance with the horizontal dimension of the display surface 20DS.

Moreover, the display unit 4 further includes the function member 63 that exhibits higher rigidity when energized than when not energized, allowing the display surface 20DS to have improved flatness when in use.

### 5. MODIFICATION EXAMPLES

Although the description has been given with reference to some embodiments and modification examples, the present disclosure is not limited thereto, and may be modified in a variety of ways. For example, in the above-described first embodiment, etc., the speakers 13L and 13R are provided inside the winder 10; however, the present disclosure is not limited thereto. According to the present disclosure, a vibration member with flexibility may be provided on a rear surface of the display section to regenerate sound information by causing vibration of the flexible vibration member, for example. Examples of such a flexible vibration member include a piezo film. In this case, a plurality of piezo films may be stacked.

In the above-described embodiments, etc., the detector is exemplified by the piezoelectric sensors, the position sensors, the imaging units, etc.; however, the present disclosure is not limited thereto and other sensors or the like may be provided if necessary.

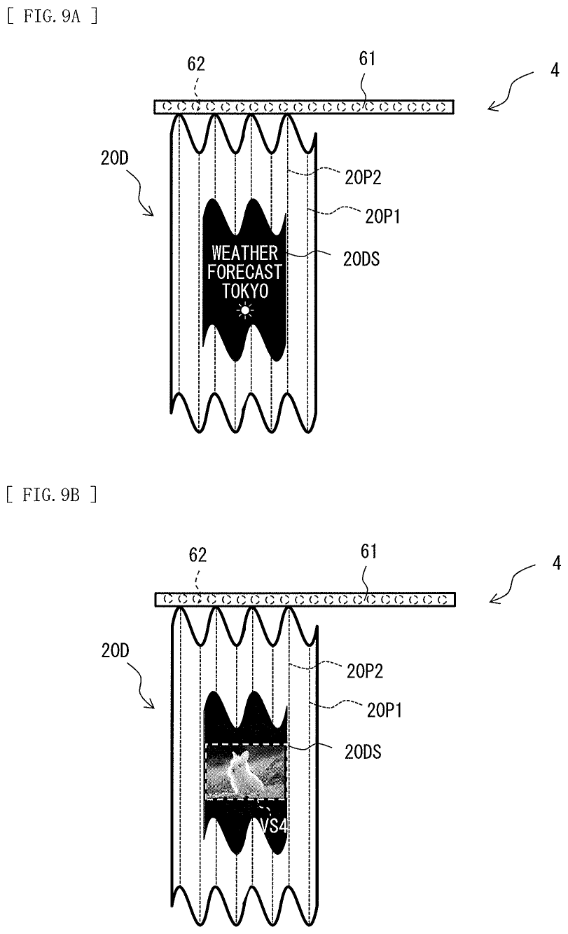

Moreover, in the description of the above-described first to fourth embodiments, the display section is exemplified by the flexible display; however, the present disclosure is not limited thereto. For example, a first display portion 21A, which is a high-rigidity display panel, and a second display portion 22A, which is a high-rigidity display panel independent of this first display portion 21A, may be disposed adjacent to each other as in a display section 20A of a display unit 1A illustrated in FIG. 10. The first display portion 21A has a first display surface 21AS and the second display portion 22A has a second display surface 22AS.

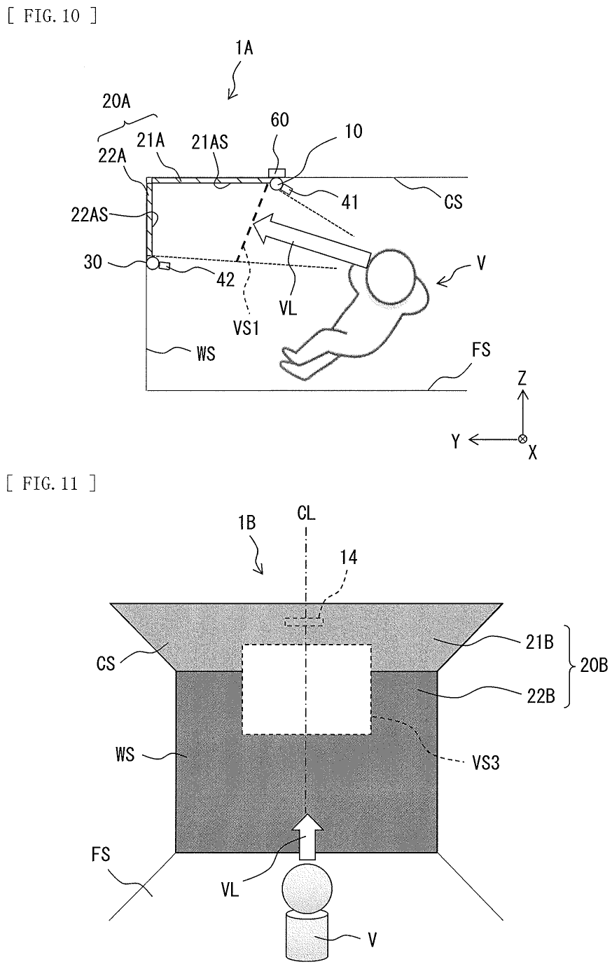

Moreover, in the above-described first embodiment, the first display portion 21 is disposed occupying only a portion of the ceiling surface CS and the second display portion 22 is disposed occupying only a portion of the wall surface WS in front of the viewer V. The present disclosure is not limited thereto. For example, a display section may include a first display portion 21B that occupies the entirety of the ceiling surface CS and a second display portion 22B that occupies the entirety of the wall surface WS as in a display section 20B of a display unit 1B illustrated in FIG. 11. In this case, it is sufficient if a direction of the face, a direction of the line of vision VL, or the like of the viewer V is detected using the imaging units 41 and 42 to move a position of a virtual screen VS3 created by the image processor 52. Further, it is sufficient if a position of a sound image created through the speakers 13L and 13R and the speakers 32L and 32R is moved in accordance with the direction of the face or the direction of the line of vision VL of the viewer V, the position of the virtual screen VS3, or the like, for example. This makes it possible for the viewer to enjoy visual expression and audio expression with a more realistic sensation.

Moreover, in the above-described first embodiment, the display section 20, which is a single sheet-shaped display device, has the first display surface 21S and the second display surface 22S; however, the present disclosure is not limited thereto and a first display section having a first display surface and a second display section having a second display surface may be independently provided and disposed adjacent to each other.

Moreover, in the above-described first embodiment, an example where the display unit 1 is in the stored state when turned off but may remain in the unwound state when turned on and off.

Moreover, in the above-described second embodiment, the plurality of piezoelectric sensors 23 detects and estimates a change in the curvature of the display surface 24S with a change in the inner diameter 24D; however, the present disclosure is not limited thereto. For example, as long as the display section 24 is able to remain in a highly precise cylindrical shape, the curvature of the display surface 24S may be controlled by, for example, controlling the width of the slit 24K without providing the plurality of piezoelectric sensors 23.

Further, the roller-blind display section 20 that is able to be stored in the winder 10 is described as an example in the above-described first embodiment and the drape-curtain display section 20D is described as an example in the above-described fourth embodiment; however, the present technology is not limited thereto. The present technology is also applicable to a blind display including a plurality of slats coupled to one another using a pole, a cord, or the like, for example.

It is to be noted that effects described herein are merely exemplified. Effects of the disclosure are not limited to the effects described herein. Effects of the disclosure may further include other effects. Moreover, the present technology may have the following configurations.
(1)

A display unit including:

a first display surface where a first image is to be displayed;

a second display surface that makes an inclination angle with respect to the first display surface and where a second image is to be displayed;

a detector that detects a relative position of a viewer who views the first image and the second image to the first display surface and the second display surface; and

a controller that corrects deformation of the first image and deformation of the second image, thereby creating a single virtual screen that faces the viewer on the basis of the relative position detected by the detector.
(2)

The display unit according to (1), in which

the detector detects a change in the relative position, and

the controller changes a position of the virtual screen in accordance with the change in the relative position.
(3)

The display unit according to (1) or (2), further including a speaker, in which the speaker creates a sound image at a position corresponding to a position of the virtual screen as seen from the viewer.
(4)

The display unit according to any one of (1) to (3), further including:

a winder including a rotary shaft; and

a flexible display, in which

the flexible display has the first display surface and the second display surface, and

the flexible display is windable with rotation of the rotary shaft and ejectable from the winder.
(5)

The display unit according to (4), in which the winder includes a contactless power supply that supplies power to the flexible display.
(6)

The display unit according to (4), in which the flexible display includes a bend detection sensor that detects an own curvature.
(7)

The display unit according to (6), in which the controller creates the virtual screen on the basis of a folding position of the flexible display detected by the bend detection sensor.
(8)

The display unit according to any one of (1) to (7), in which

the first display surface is disposed on a ceiling surface, and

the second display surface is disposed on a wall surface.
(9)

A display unit including:

a flexible display that has a curved display surface where an image is to be displayed and includes a bend detection sensor that detects a curvature of the display surface;

a detector that detects a relative position of a viewer who views the image to the display surface; and

a controller that corrects deformation of the image, thereby creating a single virtual screen that faces the viewer on the basis of the relative position detected by the detector.
(10)

A display unit that is to be installed on a wall surface along with an electronic apparatus, the electronic apparatus including a body and a cable taken from the body, the display unit including:

a winder disposed between the body of the electronic apparatus and the wall surface and including a rotary shaft; and

a flexible display that is windable with rotation of the rotary axis and drawable from the winder and is configured to cover the cable in a state where the flexible display is drawn from the winder.
(11)

A display unit including:

a guide rail that extends in a first direction; and

a flexible display having a display surface where an image is to be displayed, the flexible display being foldable along a plurality of folds that extends in a second direction intersecting the first direction and changeable in state between a folded state with a minimum dimension in the first direction and an unfolded state with a maximum dimension in the first direction.
(12)

The display unit according to (11), further including a controller, in which

the flexible display further includes a bend detection sensor that detects a curvature of the display surface, and

the controller corrects the image to be displayed on the display surface on the basis of the curvature of the display surface detected by the bend detection sensor, thereby creating a virtual screen that is parallel with a plane including both the first direction and the second direction.
(13)

The display unit according to (11) or (12), in which

the display unit is turned on during a change in a state of the flexible display from the folded state toward the unfolded state or when the flexible display reaches the unfolded state, and

the display unit is turned off during a change in the state of the flexible display from the unfolded state toward the folded state or when the flexible display reaches the folded state.
(14)

The display unit according to any one of (11) to (13), in which the flexible display is supplied with power through the guide rail.
(15)

The display unit according to any one of (11) to (14), in which the flexible display changes a size of the image in accordance with a dimension in the first direction.
(16)

The display unit according to any one of (11) to (15), in which the flexible display further includes a function member that is disposed on a rear of the display surface and exhibits higher rigidity when energized than when not energized.

This application claims the benefit of Japanese Priority Patent Application JP2017-234627 filed on Dec. 6, 2017, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A display unit comprising:
a first display surface where a first image is to be displayed;
a second display surface that makes an inclination angle with respect to the first display surface and where a second image is to be displayed;
a detector that detects a relative position of a viewer who views the first image and the second image to the first display surface and the second display surface; and
a controller that corrects deformation of the first image and deformation of the second image, thereby creating a single virtual screen that faces the viewer on a basis of the relative position detected by the detector.

2. The display unit according to claim 1, wherein
the detector detects a change in the relative position, and
the controller changes a position of the virtual screen in accordance with the change in the relative position.

3. The display unit according to claim 1, further comprising a speaker, wherein the speaker creates a sound image at a position corresponding to a position of the virtual screen as seen from the viewer.

4. The display unit according to claim 1, further comprising:
a winder including a rotary shaft; and
a flexible display, wherein
the flexible display has the first display surface and the second display surface, and
the flexible display is windable with rotation of the rotary shaft and ejectable from the winder.

5. The display unit according to claim 4, wherein the winder includes a contactless power supply that supplies power to the flexible display.

6. The display unit according to claim 4, wherein the flexible display includes a bend detection sensor that detects an own curvature.

7. The display unit according to claim 6, wherein the controller creates the virtual screen on a basis of a folding position of the flexible display detected by the bend detection sensor.

8. The display unit according to claim 1, wherein
the first display surface is disposed on a ceiling surface, and
the second display surface is disposed on a wall surface.

9. A display unit comprising:
a flexible display that has a curved display surface where an image is to be displayed and includes a bend detection sensor that detects a curvature of the display surface;
a detector that detects a relative position of a viewer who views the image to the display surface; and
a controller that corrects deformation of the image, thereby creating a single virtual screen that faces the viewer on a basis of the relative position detected by the detector.

10. A display unit that is to be installed on a wall surface along with an electronic apparatus, the electronic apparatus including a body and a cable taken from the body, the display unit comprising:
a winder disposed between the body of the electronic apparatus and the wall surface and including a rotary shaft; and
a flexible display that is windable with rotation of the rotary axis and drawable from the winder and is configured to cover the cable in a state where the flexible display is drawn from the winder.

11. A display unit comprising:
a guide rail that extends in a first direction; and
a flexible display having a display surface where an image is to be displayed, the flexible display being foldable along a plurality of folds that extends in a second direction intersecting the first direction and changeable in state between a folded state with a minimum dimension in the first direction and an unfolded state with a maximum dimension in the first direction.

12. The display unit according to claim 11, further comprising a controller, wherein
the flexible display further includes a bend detection sensor that detects a curvature of the display surface, and
the controller corrects the image to be displayed on the display surface on a basis of the curvature of the display surface detected by the bend detection sensor, thereby creating a virtual screen that is parallel with a plane including both the first direction and the second direction.

13. The display unit according to claim 11, wherein
the display unit is turned on during a change in a state of the flexible display from the folded state toward the unfolded state or when the flexible display reaches the unfolded state, and
the display unit is turned off during a change in the state of the flexible display from the unfolded state toward the folded state or when the flexible display reaches the folded state.

14. The display unit according to claim 11, wherein the flexible display is supplied with power through the guide rail.

15. The display unit according to claim 11, wherein the flexible display changes a size of the image in accordance with a dimension in the first direction.

16. The display unit according to claim 11, wherein the flexible display further includes a function member that is disposed on a rear of the display surface and exhibits higher rigidity when energized than when not energized.
